(19) United States
(12) Patent Application Publication
(10) Pub. No.: US 2009/0314558 A1
(43) Pub. Date: Dec. 24, 2009

(54) Voltage Conversion Apparatus and Vehicle Including the Same

(75) Inventors: Wangleng Ang, Aichi-ken (JP); Hiroki Sawada, Aichi-ken (JP); Hiroshi Yoshida, Aichi-ken (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 12/227,949

(22) PCT Filed: Jun. 20, 2007
(86) PCT No.: PCT/JP2007/062838

§ 371 Date: Dec. 3, 2008

(30) Foreign Application Priority Data
Jul. 3, 2006 (JP) 2006-183525

(51) Int. Cl. B60K 1/00; H02M 7/00

(52) U.S. Cl. 180/65.1; 307/82

(57) ABSTRACT

A voltage control portion generates a current command for controlling a voltage to an inverter input voltage command. A dividing portion divides the current command into first and second current commands in accordance with a division ratio from a division ratio setting portion. A first current control portion generates a modulated wave for controlling a current of a first converter to the first current command. A second current control portion generates a modulated wave for controlling a current of a second converter to the second current command.

### TECHNICAL FIELD

The present invention relates to a voltage conversion apparatus and a vehicle including the same, and more particularly, to a voltage conversion apparatus including a plurality of converters connected in parallel, and a vehicle including the same.

### BACKGROUND ART

Japanese Patent Laying-Open No. 2003-199203 discloses an electric circuit where energy accumulating means is connected between a direct current (DC) source and an inverter with a DC/DC converter interposed therebetween. This electric circuit includes the inverter driving a motor load, a smoothing capacitor suppressing an instantaneous ripple of a DC input voltage of the inverter, the DC source supplying a DC voltage to the inverter, the DC/DC converter connected in parallel to the DC source, and regenerated-energy accumulating means connected to the DC/DC converter.

In this electric circuit, a DC input voltage of the inverter is detected, and when the detected voltage exceeds a set level, a conduction ratio of the DC/DC converter is changed to increase a charging current to the regenerated-energy accumulating means. As a result, the inverter, the DC/DC converter and the regenerated-energy accumulating means are protected.

In the electric circuit disclosed in this publication, the DC source and the DC/DC converter are connected in parallel, and the regenerated-energy accumulating means is connected to the DC/DC converter. In other words, two DC power supplies are connected in parallel to a DC input of the inverter.

The above-described publication, however, only discloses a technique for protecting the circuit when excessive regenerated energy is supplied from the motor load, and it is not assumed that both of the two DC power supplies connected in parallel are used to supply electric power to the inverter. In other words, in the electric circuit disclosed in the above-described publication, the regenerated-energy accumulating means is used instead of the DC source when electric power supply from the DC source stops or when a voltage thereof is decreased.

On the other hand, in a case where a plurality of DC power supplies connected in parallel are used to supply electric power to the inverter, in order to supply a steady voltage, a converter needs to be provided corresponding to each DC power supply. Where a plurality of converters are arranged in parallel, however, control over each converter interferes with one another and an inverter input voltage can fluctuate.

Therefore, it is considered, for example, that one converter (hereinafter, a first converter) is voltage-controlled and the other converter (hereinafter, a second converter) is current-controlled. For example, in a case where it is desired that the first converter is stopped and only the second converter is operated, however, it is necessary to switch the second converter from current-control to voltage-control, and then to stop the first converter. Thus, it is difficult to avoid fluctuations in the inverter input voltage at the time of such control switching.

### DISCLOSURE OF THE INVENTION

Therefore, an object of the present invention is to provide a voltage conversion apparatus in which load distribution of a plurality of converters connected in parallel can readily be changed and fluctuations in an output voltage can be suppressed.

Another object of the present invention is to provide a vehicle including a voltage conversion apparatus in which load distribution of a plurality of converters connected in parallel can readily be changed and fluctuations in an output voltage can be suppressed.

According to the present invention, the voltage conversion apparatus includes a plurality of converters and a control device controlling the plurality of converters. The plurality of converters are connected in parallel to one another and connected to an electric load. Each converter converts a voltage from a corresponding power storage device and outputs the converted voltage to the electric load. The control device includes a voltage control portion, a dividing portion and a plurality of current control portions. The voltage control portion generates a first current command for controlling an input voltage of the electric load to a target voltage. The dividing portion divides the first current command into a plurality of second current commands for the plurality of converters in accordance with a predetermined division ratio. The plurality of current control portions are provided corresponding to the plurality of converters, and each current control portion controls a current shared by a corresponding converter to a corresponding second current command.

Preferably, the predetermined division ratio is decided based on required power of the electric load.

Preferably, the predetermined division ratio is decided such that a total loss of the plurality of power storage devices is minimized.

Preferably, the control device further includes a stop control portion providing a stop instruction of a switching operation to a converter to which the second current command of 0 is provided.

According to the present invention, a vehicle includes any of the voltage conversion apparatuses described above, a drive device receiving a voltage from the voltage conversion apparatus, a motor driven by the drive device, and a wheel having a rotation shaft coupled to an output shaft of the motor.

In the present invention, the plurality of converters are connected in parallel to one another and connected to the electric load, and the voltage control portion generates the first current command for controlling the input voltage of the electric load to the target voltage. The dividing portion divides the first current command into the plurality of second current commands in accordance with the predetermined division ratio, and each current control portion controls the current shared by the corresponding converter to the corresponding second current command. Therefore, the sharing rate of each converter can be arbitrarily changed by changing the division ratio while ensuring a total amount of current for controlling the input voltage of the electric load to the target voltage. In other words, even if the sharing rate of each converter is changed based on the division ratio, the total amount of current for controlling the input voltage of the electric load to the target voltage is ensured.

Therefore, according to the present invention, load distribution of the plurality of converters connected in parallel can readily be changed and fluctuations in the input voltage of the electric load having the plurality of converters connected can be suppressed.

### BRIEF DESCRIPTION OF THE DRAWINGS

FIG. 1 is an overall block diagram of a hybrid vehicle shown as an example of a vehicle according to the present invention.

FIG. 2 is a circuit diagram of a configuration of a converter shown in FIG. 1.

FIG. 3 is a functional block diagram of an ECU shown in FIG. 1.

FIG. 4 is a functional block diagram of a converter control portion shown in FIG. 3.

FIG. 5 is a functional block diagram of a voltage control portion shown in FIG. 4.

FIG. 6 is a functional block diagram of a current control portion shown in FIG. 4.

FIG. 7 is a functional block diagram of a converter control portion in a second embodiment.

FIG. 8 is an overall block diagram of a hybrid vehicle including three converters.

FIG. 9 is a functional block diagram of a converter control portion in the hybrid vehicle shown in FIG. 8.

### BEST MODES FOR CARRYING OUT THE INVENTION

The embodiments of the present invention will be described in detail hereinafter with reference to the drawings, where the same or corresponding parts are represented by the same reference characters, and the description thereof will not be repeated.

### First Embodiment

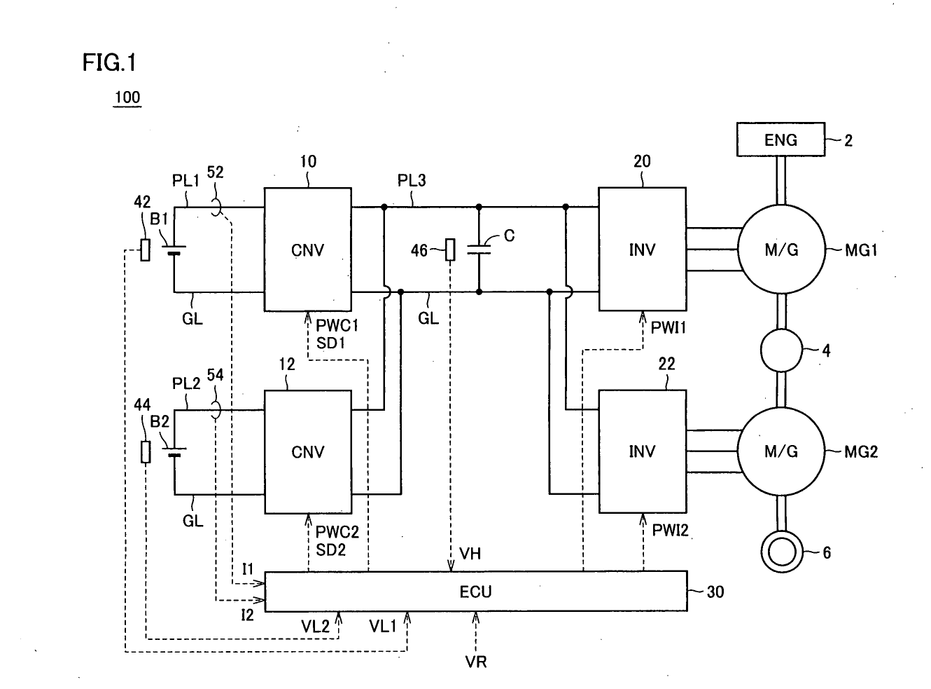

FIG. 1 is an overall block diagram of a hybrid vehicle represented as an example of a vehicle according to the present invention. Referring to FIG. 1, this hybrid vehicle 100 includes an engine 2, motor generators MG1 and MG2, a power split device 4, and wheels 6. Hybrid vehicle 100 further includes power storage devices B1 and B2, converters 10 and 12, a capacitor C, inverters 20 and 22, an ECU (Electronic Control Unit) 30, voltage sensors 42, 44 and 46, and current sensors 52 and 54.

This hybrid vehicle 100 runs by employing engine 2 and motor generator MG2 as a source of motive power. Power split device 4 is coupled to engine 2 and motor generators MG1 and MG2 to divide motive power therebetween. Power split device 4 is formed of, for example, a planetary gear mechanism having three rotation shafts of a sun gear, a planetary carrier and a ring gear. These three rotation shafts are connected to rotation shafts of engine 4 and motor generators MG1 and MG2, respectively. A rotor of motor generator MG1 is hollowed and a crankshaft of engine 2 passes through the center thereof, so that engine 2 and motor generators MG1 and MG2 are mechanically connected to power split device 4. Furthermore, the rotation shaft of motor generator MG2 is coupled to wheels 6 through a reduction gear and a differential gear that are not shown.

Motor generator MG1 is incorporated into hybrid vehicle 100 as a motor generator operating as a generator driven by engine 2 and operating as a motor that can start up engine 2. Motor generator MG2 is incorporated into hybrid vehicle 100 as a motor that drives wheels 6.

Power storage devices B1 and B2 are chargeable and dischargeable DC power supplies and are formed of, for example, secondary batteries such as nickel-hydride batteries or lithium-ion batteries. Power storage device B1 supplies electric power to converter 10, and is charged by converter 10 during regeneration of electric power. Power storage device B2 supplies electric power to converter 12, and is charged by converter 12 during regeneration of electric power.

A secondary battery whose maximum electric power that can be output is larger than that of power storage device B2 can be used in power storage device B1, and a secondary battery whose power storage capacity is larger than that of power storage device B1 can be used in power storage device B2. As a result, the use of two power storage devices B1 and B2 allows a DC power supply of high power and large capacity to be formed. It should be noted that a capacitor of large capacitance may be used as power storage devices B1 and B2.

Converter 10 boosts a voltage from power storage device B1 based on a signal PWC1 from ECU 30 and outputs the boosted voltage to a power supply line PL3. Furthermore, converter 10 steps down regenerative electric power supplied from inverters 20 and 22 via power supply line PL3 to a voltage level of power storage device B1 based on signal PWC1, and charges power storage device B1. In addition, upon receiving a shutdown signal SD1 from ECU 30, converter 10 stops a switching operation.

Converter 12 is connected to power supply line PL3 and a ground line GL in parallel to converter 10. Converter 12 boosts a voltage from power storage device B2 based on a signal PWC2 from ECU 30 and outputs the boosted voltage to power supply line PL3. Furthermore, converter 12 steps down regenerative electric power supplied from inverters 20 and 22 via power supply line PL3 to a voltage level of power storage device B2 based on signal PWC2, and charges power storage device B2. In addition, upon receiving a shutdown signal SD2 from ECU 30, converter 12 stops a switching operation.

Capacitor C is connected between power supply line PL3 and ground line GL, and smoothes voltage fluctuations between power supply line PL3 and ground line GL.

Inverter 20 converts a DC voltage from power supply line PL3 into a three-phase alternating current (AC) voltage based on a signal PWI1 from ECU 30 and outputs the converted three-phase AC voltage to motor generator MG1. Furthermore, inverter 20 converts a three-phase AC voltage generated by motor generator MG1 with motive power of engine 2 into a DC voltage based on signal PWI1 and outputs the converted DC voltage to power supply line PL3.

Inverter 22 converts a DC voltage from power supply line PL3 into a three-phase AC voltage based on a signal PWI2 from ECU 30 and outputs the converted three-phase AC voltage to motor generator MG2. Furthermore, during regenerative braking of the vehicle, inverter 22 converts a three-phase AC voltage generated by motor generator MG2 by receiving the rotational force of wheels 6 into a DC voltage based on signal PWI2, and outputs the converted DC voltage to power supply line PL3.

Each of motor generators MG1 and MG2 is a three-phase AC rotating electric machine and is formed of, for example, a three-phase AC synchronous motor generator. Motor generator MG1 is driven to carry out the regenerative operation by inverter 20 and outputs a three-phase AC voltage generated with motive power of engine 2 to inverter 20. Furthermore, at the time of start-up of engine 2, motor generator MG1 is driven to carry out the power running by inverter 20 and cranks up engine 2. Motor generator MG2 is driven to carry out the power running by inverter 22 and generates the driving force for driving wheels 6. Furthermore, during regenerative braking of the vehicle, motor generator MG2 is driven to carry out the regenerative operation by inverter 22 and outputs a three-phase AC voltage generated with the rotational force received from wheels 6 to inverter 22.

Voltage sensor 42 detects a voltage VL1 of power storage device B1 and outputs the detected voltage to ECU 30. Current sensor 52 detects a current I1 output from power storage device B1 to converter 10 and outputs the detected current to ECU 30. Voltage sensor 44 detects a voltage VL2 of power storage device B2 and outputs the detected voltage to ECU 30. Current sensor 54 detects a current I2 output from power storage device B2 to converter 12 and outputs the detected current to ECU 30. Voltage sensor 46 detects a voltage across the terminals of capacitor C, that is, a voltage VH of power supply line PL3 with respect to ground line GL, and outputs detected voltage VH to ECU 30.

ECU 30 generates signals PWC1 and PWC2 for driving converters 10 and 12, respectively, and outputs generated signals PWC1 and PWC2 to converters 10 and 12, respectively. Furthermore, ECU 30 generates signals PWI1 and PWI2 for driving inverters 20 and 22, respectively, and outputs generated signals PWI1 and PWI2 to inverters 20 and 22, respectively.

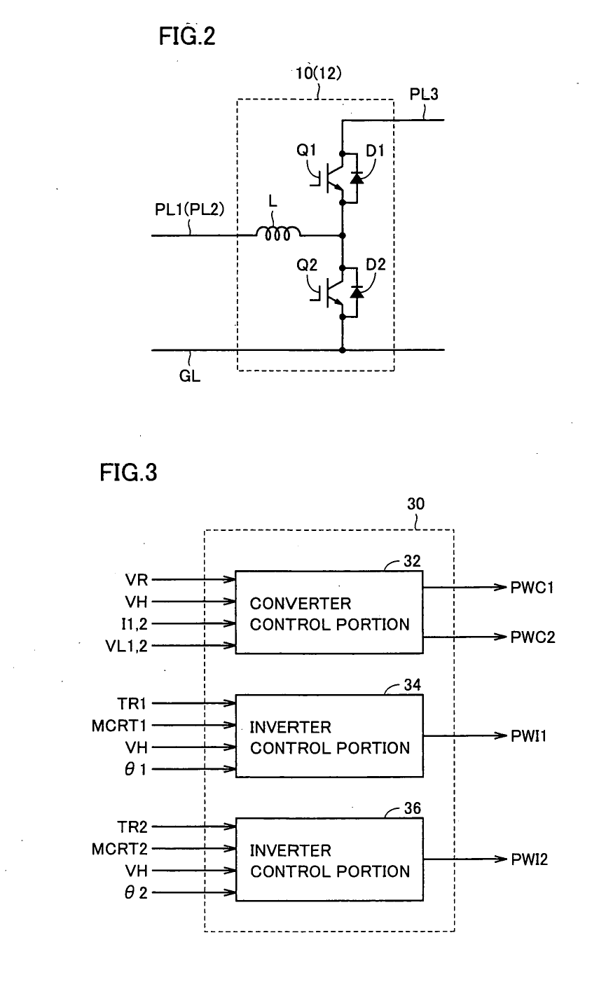

FIG. 2 is a circuit diagram of a configuration of converter 10 or 12 shown in FIG. 1. Referring to FIG. 2, converter 10 (12) includes npn-type transistors Q1 and Q2, diodes D1 and D2, and a reactor L. Npn-type transistors Q1 and Q2 are connected in series between power supply line PL3 and ground line GL. Diodes D1 and D2 are connected in antiparallel to npn-type transistors Q1 and Q2, respectively. Reactor L has one end connected to a connection node of npn-type transistors Q1 and Q2, and the other end connected to power supply line PL1 (PL2). It should be noted that an IGBT (Insulated Gate Bipolar Transistor), for example, can be used as the above-described npn-type transistors.

This converter 10 (12) is formed of a chopper circuit. Converter 10 (12) boosts a voltage of power supply line PL1 (PL2) using reactor L based on signal PWC1 (PWC2) from ECU 30 (not shown), and outputs the boosted voltage to power supply line PL3.

Specifically, converter 10 (12) stores in reactor L a current flowing when npn-type transistor Q2 is turned on as magnetic field energy, so that converter 10 (12) boosts a voltage of power supply line PL1 (PL2). Converter 10 (12) outputs the boosted voltage to power supply line PL3 via diode D1 in synchronization with the timing when npn-type transistor Q2 is turned off.

FIG. 3 is a functional block diagram of ECU 30 shown in FIG. 1. Referring to FIG. 3, ECU 30 includes a converter control portion 32 and inverter control portions 34 and 36.

Converter control portion 32 receives an inverter input voltage command VR, voltage VH from voltage sensor 46, currents I1 and I2 from current sensors 52 and 54, and voltages VL1 and VL2 from voltage sensors 42 and 44. Then, converter control portion 32 generates signal PWC1 for turning on/off npn-type transistors Q1 and Q2 of converter 10 as well as signal PWC2 for turning on/off npn-type transistors Q1 and Q2 of converter 12, based on each of the signals described above, and outputs generated signals PWC1 and PWC2 to converters 10 and 12, respectively. It should be noted that the configuration of converter control portion 32 will be described later in detail.

Inverter control portion 34 receives a torque command TR1, a motor current MCRT1 and a rotation angle θ1 of the rotor of motor generator MG1 as well as voltage VH. Then, inverter control portion 34 generates signal PWI1 for turning on/off a power transistor included in inverter 20, based on each of the signals described above, and outputs generated signal PWI1 to inverter 20.

Inverter control portion 36 receives a torque command TR2, a motor current MCRT2 and a rotation angle θ2 of a rotor of motor generator MG2 as well as voltage VH. Then, inverter control portion 36 generates signal PWI2 for turning on/off a power transistor included in inverter 22, based on each of the signals described above, and outputs generated signal PWI2 to inverter 22.

It should be noted that inverter input voltage command VR is calculated by an external ECU (not shown, and the same is true of the following) based on, for example, required power of motor generators MG1 and MG2. Furthermore, torque commands TR1 and TR2 are calculated by the external ECU based on, for example, an accelerator opening degree, an amount by which the brake is pressed, a vehicle speed, or the like. Each of motor currents MCRT1 and MCRT2 as well as rotation angles θ1 and θ2 of the rotors is detected by a not-shown sensor.

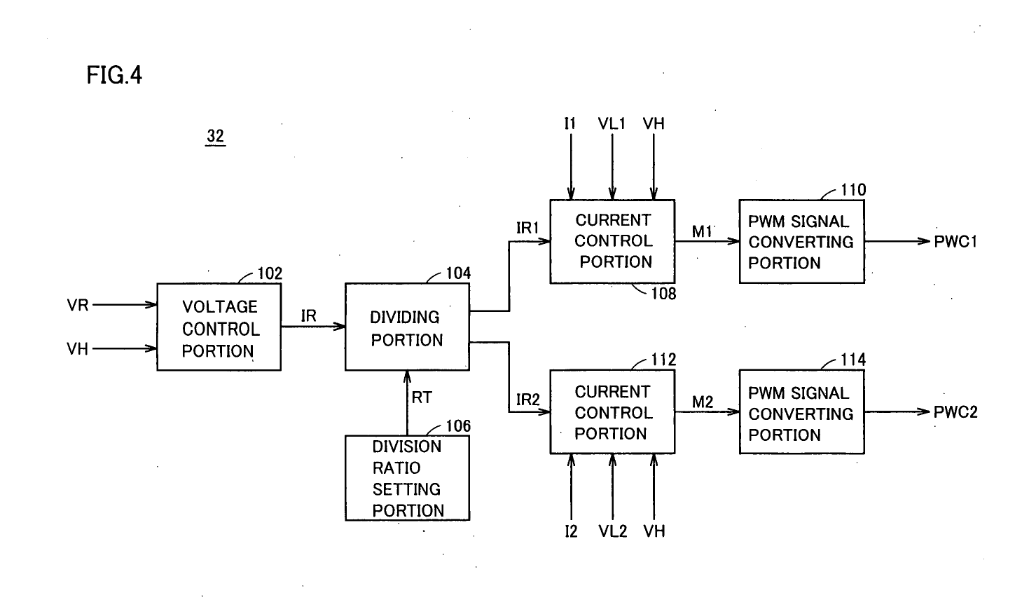

FIG. 4 is a functional block diagram of converter control portion 32 shown in FIG. 3. Referring to FIG. 4, converter control portion 32 includes a voltage control portion 102, a dividing portion 104, a division ratio setting portion 106, current control portions 108 and 112, and PWM signal generating portions 110 and 114.

Voltage control portion 102 calculates a current command IR for controlling voltage VH to inverter input voltage command VR, based on inverter input voltage command VR and voltage VH from voltage sensor 46, and outputs calculated current command IR to dividing portion 104.

Dividing portion 104 divides current command IR from voltage control portion 102 into a current command IR1 for converter 10 and a current command IR2 for converter 12 in accordance with a division ratio RT set by division ratio setting portion 106, and outputs divided current commands IR1 and IR2 to current control portions 108 and 112, respectively.

Division ratio setting portion 106 decides division ratio RT (0≦RT≦1) for dividing current command IR into current commands IR1 and IR2, and outputs decided division ratio RT to dividing portion 104. Division ratio RT can be decided based on, for example, required power of motor generators MG1 and MG2. Specifically, if the required power is larger than a reference value, division ratio RT is set to a value other than 0 or 1 and parallel operation of converters 10 and 12 can be performed. If the required power is smaller than the reference value, the division ratio is set to 0 or 1 and single operation of either converter 10 or 12 can be performed.

As described above, in a case where power storage devices B1 and B2 have different properties, that is, in a case where a secondary battery whose maximum electric power that can be output is large is used in power storage device B1 and a secondary battery whose power storage capacity is large is used in power storage device B2, division ratio RT may be decided such that the division ratio of current command IR1 is increased as the required power is increased. In other words, division ratio RT may be decided such that the division ratio of current command IR2 is increased as the required power is decreased. As a result, when the required power is large, the utilization rate of power storage device B1 whose maximum electric power that can be output is large is increased, and when the required power is small, the utilization rate of power storage device B2 whose power storage capacity is large is increased. Therefore, appropriate operations in accordance with the properties of power storage devices B1 and B2 can be realized.

Current control portion 108 generates a modulated wave M1 for controlling current I1 to current command IR1, based on current command IR1 from dividing portion 104, current I1 from current sensor 52 as well as voltages VL1 and VH from voltage sensors 42 and 46, and outputs generated modulated wave M1 to PWM signal converting portion 110.

PWM signal converting portion 110 generates a PWM (Pulse Width Modulation) signal for turning on/off npn-type transistors Q1 and Q2 of converter 10, based on modulated wave M1 from current control portion 108 and a predetermined carrier, and outputs the generated PWM signal to npn-type transistors Q1 and Q2 of converter 10 as signal PWC1.

Current control portion 112 generates a modulated wave M2 for controlling current I2 to current command IR2, based on current command IR2 from dividing portion 104, current I2 from current sensor 54 as well as voltages VL1 and VH, and outputs generated modulated wave M2 to PWM signal converting portion 114.

PWM signal converting portion 114 generates a PWM signal for turning on/off npn-type transistors Q1 and Q2 of converter 12, based on modulated wave M2 from current control portion 112 and a predetermined carrier, and outputs the generated PWM signal to npn-type transistors Q1 and Q2 of converter 12 as signal PWC2.

FIG. 5 is a functional block diagram of voltage control portion 102 shown in FIG. 4. Referring to FIG. 5, voltage control portion 102 includes a subtraction portion 202 and a PI control portion 204. Subtraction portion 202 subtracts voltage VH from voltage sensor 46 from inverter input voltage command VR, and outputs the result of the calculation to PI control portion 204.

PI control portion 204 receives from subtraction portion 202 a difference between inverter input voltage command VR and voltage VH, performs a proportional and integral calculation by using the difference as an input, and outputs the result of the calculation as current command IR.

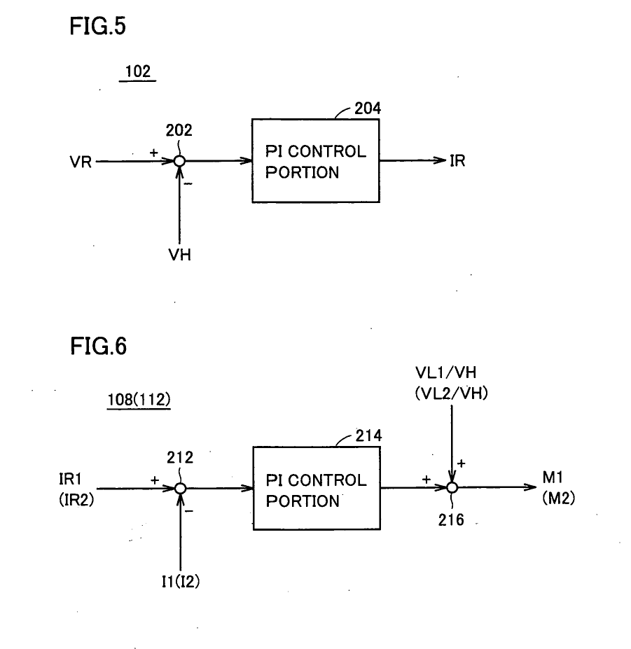

FIG. 6 is a functional block diagram of current control portion 108 or 112 shown in FIG. 4. Referring to FIG. 6, current control portion 108 (112) includes a subtraction portion 212, a PI control portion 214 and an addition portion 216. Subtraction portion 212 subtracts current I1 (I2) received from current sensor 52 (54) from current command IR1 (IR2), and outputs the result of the calculation to PI control portion 214.

PI control portion 214 receives from subtraction portion 212 a difference between current command IR1 (IR2) and current I1 (I2), performs a proportional and integral calculation by using the difference as an input, and outputs the result of the calculation to addition portion 216.

Addition portion 216 adds an amount of feedforward compensation VL1/VH (VL2/VH) to the result of the calculation by PI control portion 214 and outputs the result of the calculation as modulated wave M1 (M2).

Referring again to FIG. 4, in this converter control portion 32, current command IR for controlling voltage VH to inverter input voltage command VR is generated by voltage control portion 102, and current command IR is divided into current commands IR1 and IR2 by dividing portion 104 in accordance with division ratio RT from division ratio setting portion 106. Modulated wave M1 for controlling current I1 of converter 10 to current command IR1 is generated by current control portion 108, and modulated wave M2 for controlling current I2 of converter 12 to current command IR2 is generated by current control portion 112.

In other words, in the present first embodiment, a current (corresponding to current command IR) required for voltage-control of voltage VH is shared by converters 10 and 12. Although each of currents I1 and I2 of converters 10 and 12 may vary in accordance with division ratio RT, a total of currents I1 and I2 is constantly controlled to current command IR, so that voltage VH is maintained at inverter input voltage command VR even if the sharing rate of converters 10 and 12 is changed.

Therefore, shift from parallel operation of converters 10 and 12 to individual operation of converter 10 or 12 (corresponding to the situation where division ratio RT is 0 or 1), or shift from individual operation of converter 10 or 12 to parallel operation of converters 10 and 12 can be realized without fluctuations in voltage VH.

As described above, in the present first embodiment, current command IR for controlling voltage VH to a target voltage is divided into current commands IR1 and IR2 by dividing portion 104. Currents I1 and I2 of converters 10 and 12 are controlled to current commands IR1 and IR2 by current control portions 108 and 112, respectively. Therefore, the sharing rate of converters 10 and 12 can be arbitrarily changed by changing division ratio RT while ensuring a total amount of current for controlling voltage VH to the target voltage. In other words, even if the sharing rate of converters 10 and 12 is changed based on division ratio RT, the total amount of current for controlling voltage VH to the target voltage is ensured.

Therefore, according to the present first embodiment, load distribution of converters 10 and 12 can readily be changed and fluctuations in a voltage of power supply line PL3 having converters 10 and 12 connected can be suppressed.

Furthermore, shift between parallel operation of converters 10 and 12 and single operation of converter 10 or 12 can readily be realized without affecting control over motor generators MG1 and MG2 by inverters 20 and 22. In addition, flexibility of operations of power storage devices B1 and B2 is increased, which may contribute to long-lived power storage devices B1 and B2. Moreover, in a case where power storage devices B1 and B2 have different properties as described above, appropriate operations in accordance with the properties of power storage devices B1 and B2 can be realized depending on required power.

### Modification of First Embodiment

Although division ratio setting portion 106 decides division ratio RT based on required power of motor generators MG1 and MG2 in the above, division ratio RT may be decided such that a total loss of power storage devices B1 and B2 is minimized. A method of deciding the division ratio according to the present modification will be described hereinafter.

A loss Ploss 1 in power storage device B1 when a current corresponding to current command IR1 flows from power storage device B1 to converter 10 as well as a loss Ploss 2 in power storage device B2 when a current corresponding to current command IR2 flows from power storage device B2 to converter 12 are expressed by the following equations.

Ploss 1=R1(T1,SOC1)×IR12 (1)

Ploss 2=R2(T2,SOC2)×IR22 (2)

In these equations, R1, T1 and SOC1 represent an internal resistance, a temperature and a state of charge of power storage device B1, respectively, and R1 (T1, SOC1) indicates that internal resistance R1 is a function of temperature T1 and state of charge SOC1. R2, T2 and SOC2 represent an internal resistance, a temperature and a state of charge of power storage device B2, respectively, and R2 (T2, SOC2) indicates that internal resistance R2 is a function of temperature T2 and state of charge SOC2. It should be noted that temperatures T1 and T2 are detected by a not-shown temperature sensor, and states of charge SOC1 and SOC2 are calculated by the not-shown external ECU.

On the other hand, current commands IR1 and IR2 are expressed by the following equations by using current command IR and division ratio RT.

IR1=IR×RT (3)

IR2=IR×(1−RT) (4)

By substituting equations (3) and (4) into (1) and (2), losses Ploss 1 and Ploss 2 are expressed by the following equations.

Ploss 1=R1(T1,SOC1)×IR2×RT2 (5)

Ploss 2=R2(T2,SOC2)×IR2×(1−RT)2 (6)

Therefore, a total loss Ploss (=Ploss 1+Ploss 2) of power storage devices B1 and B2 is a quadratic function of division ratio RT, and division ratio RT at which total loss Ploss is minimized can be decided. It should be noted that internal resistance R1 (T1, SOC1) and R2 (T2, SOC2) can be determined by using a preset map or function equation.

As described above, according to the modification of the present first embodiment, the total loss of power storage devices B1 and B2 can be minimized.

### Second Embodiment

In a second embodiment, when any of current commands IR1 and IR2 is set to substantially 0, a switching operation of the corresponding converter is stopped (that is, shut down). As a result, a switching loss of the converter is reduced.

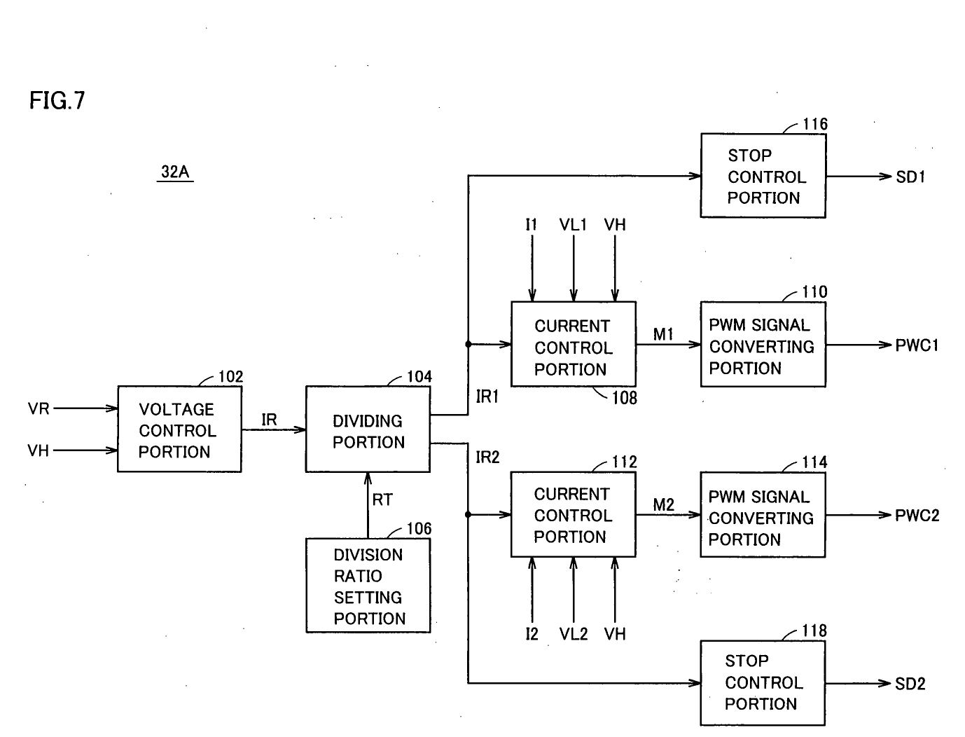

FIG. 7 is a functional block diagram of a converter control portion in the second embodiment. Referring to FIG. 7, this converter control portion 32A further includes stop control portions 116 and 118 in the configuration of converter control portion 32 in the first embodiment shown in FIG. 4.

Stop control portion 116 receives current command IR1 from dividing portion 104. When current command IR1 falls below a threshold value indicating that current command IR1 is 0, stop control portion 116 generates shutdown signal SD1 for shutdown of converter 10, and outputs the generated signal to converter 10.

Stop control portion 118 receives current command IR2 from dividing portion 104. When current command IR2 falls below a threshold value indicating that current command IR2 is 0, stop control portion 118 generates shutdown signal SD2 for shutdown of converter 12, and outputs the generated signal to converter 12.

In this converter control portion 32A, in addition to the functions of converter control portion 32 in the first embodiment, shutdown signal SD1 is output to converter 10 when current command IR1 is set to 0, and shutdown signal SD2 is output to converter 12 when current command IR2 is set to 0. As a result, the switching operation of the converter having the current command of 0 is stopped.

As described above, according to the present second embodiment, the converter to which the current command of 0 is provided is shut down, so that a switching loss of the converter can be reduced by just that amount.

Although two converters 10 and 12 are connected in parallel to power supply line PL3 and ground line GL in the first and second embodiments described above, the number of converters can readily be increased to three or more.

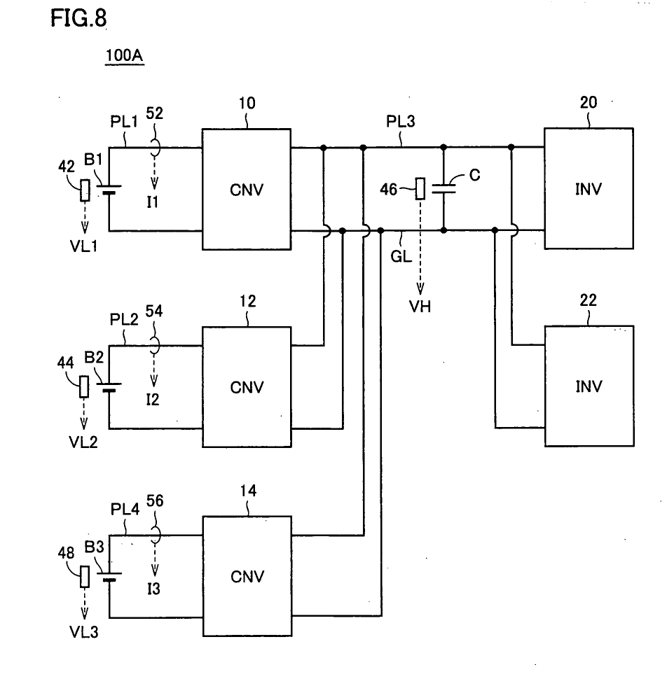

FIG. 8 is an overall block diagram of a hybrid vehicle including three converters. Referring to FIG. 8, a hybrid vehicle 100A further includes a power storage device B3, a converter 14, a voltage sensor 48, and a current sensor 56 in the configuration of hybrid vehicle 100 shown in FIG. 1. It should be noted that illustration of ECU 30, engine 2, motor generators MG1 and MG2, power split device 4, and wheels 6 is not given in this FIG. 8.

Converter 14 has a configuration similar to those of converters 10 and 12, and is connected to power supply line PL3 and ground line GL in parallel to converters 10 and 12. Power storage device B3 supplies electric power to converter 14, and is charged by converter 14 during regeneration of electric power. Voltage sensor 48 detects a voltage VL3 of power storage device B3 and outputs the detected voltage to ECU 30. Current sensor 56 detects a current I3 output from power storage device B3 to converter 14 and outputs the detected current to ECU 30.

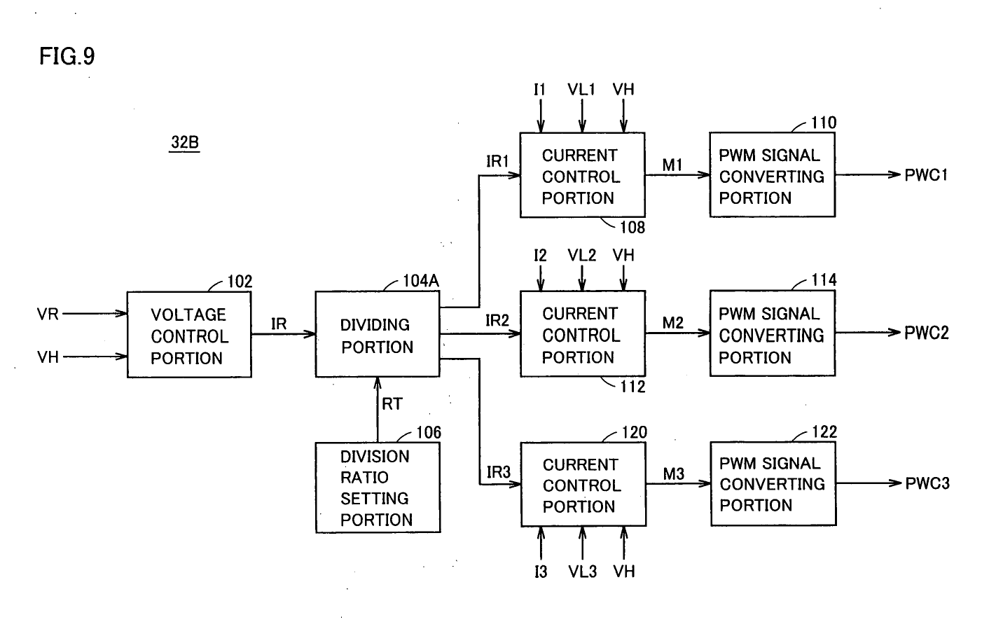

FIG. 9 is a functional block diagram of a converter control portion in hybrid vehicle 100A shown in FIG. 8. Referring to FIG. 9, a converter control portion 32B further includes a current control portion 120 and a PWM signal converting portion 122 in the configuration of converter control portion 32 shown in FIG. 4, and includes a dividing portion 104A instead of dividing portion 104.

Dividing portion 104A divides current command IR from voltage control portion 102 into current commands IR1-IR3 in accordance with division ratio RT set by division ratio setting portion 106. Current control portion 120 has a configuration similar to those of current control portions 108 and 112. Current control portion 120 generates a modulated wave M3 based on current command IR3 from dividing portion 104A, current I3 from current sensor 56 as well as voltages VL3 and VH from voltage sensors 48 and 46, and outputs the generated modulated wave to PWM signal converting portion 122. PWM signal converting portion 122 generates a signal PWC3 for driving converter 14, based on modulated wave M3, and outputs generated signal PWC3 to converter 14.

With such a configuration, although each of currents I1-I3 may vary in accordance with division ratio RT, a total of currents I1-I3 is constantly controlled to current command IR, so that voltage VH does not fluctuate in accordance with changes of the division ratio.

Although voltage control portion 102 and current control portions 108, 112 and 120 perform PI control in each embodiment described above, other control methods may be applied.

In the above, a so-called series/parallel-type hybrid vehicle has been described, in which motive power of engine 2 is divided into motor generator MG1 and wheels 6 by employing power split device 4. The present invention, however, is also applicable to a so-called series-type hybrid vehicle using motive power of engine 2 only for electric power generation by motor generator MG1 and generating the driving force of the vehicle by employing only motor generator MG2.

In addition, the present invention is also applicable to an electric vehicle that runs with only electric power without having engine 2, or a fuel cell vehicle that further includes a fuel cell as a power source.

In the above, converters 10, 12 and 14 correspond to “plurality of converters” in the present invention, and ECU 30 corresponds to “control device” in the present invention. In addition, inverters 20 and 22 form “drive device” in the present invention, and motor generators MG1 and MG2 correspond to “motor” in the present invention.

It should be understood that the embodiments disclosed herein are illustrative and not limitative in any respect. The scope of the present invention is defined by the terms of the claims, rather than the description above, and is intended to include any modifications within the scope and meaning equivalent to the terms of the claims.

1. A voltage conversion apparatus, comprising:
a plurality of converters provided corresponding to a plurality of power storage devices, connected in parallel to one another and connected to an electric load; and
a control device controlling said plurality of converters,
each of said plurality of converters being configured to convert a voltage from a corresponding power storage device and output the converted voltage to said electric load,
said control device including
a voltage control portion generating a first current command for controlling an input voltage of said electric load to a target voltage,
a dividing portion dividing said first current command into a plurality of second current commands for said plurality of converters in accordance with a predetermined division ratio, and
a plurality of current control portions provided corresponding to said plurality of converters for controlling a current shared by each converter to a corresponding second current command.

2. The voltage conversion apparatus according to claim 1, wherein
said predetermined division ratio is decided based on required power of said electric load.

3. The voltage conversion apparatus according to claim 1, wherein
said predetermined division ratio is decided such that a total loss of said plurality of power storage devices is minimized.

4. The voltage conversion apparatus according to claim 1, wherein
said control device further includes a stop control portion providing a stop instruction of a switching operation to a converter to which said second current command of 0 is provided.

5. A vehicle, comprising:
a plurality of power storage devices;
a voltage conversion apparatus;
a drive device receiving a voltage from said voltage conversion apparatus;
a motor driven by said drive device; and
a wheel having a rotation shaft coupled to an output shaft of said motor,
said voltage conversion apparatus including
a plurality of converters provided corresponding to said plurality of power storage devices, connected in parallel to one another and connected to said drive device, and
a control device controlling said plurality of converters,
each of said plurality of converters being configured to convert a voltage from a corresponding power storage device and output the converted voltage to said drive device,
said control device having
a voltage control portion generating a first current command for controlling an input voltage of said drive device to a target voltage,
a dividing portion dividing said first current command into a plurality of second current commands for said plurality of converters in accordance with a predetermined division ratio, and
a plurality of current control portions provided corresponding to said plurality of converters for controlling a current shared by each converter to a corresponding second current command.
